(19) United States
(12) Patent Application Publication
(10) Pub. No.: US 2025/0219147 A1
(43) Pub. Date: Jul. 3, 2025

(54) ADDITIVE COMPOSITION FOR LITHIUM-ION BATTERY ELECTROLYTE, ELECTROLYTE COMPRISING ADDITIVE COMPOSITION, AND USE OF ELECTROLYTE

(71) Applicant: SUZHOU CHEERCHEM ADVANCED MATERIAL CO., LTD., Suzhou (CN)

(72) Inventors: Renjun FU, Suzhou (CN); Bin DONG, Suzhou (CN); Dongqing YU, Suzhou (CN)

(21) Appl. No.: 19/086,214

(22) Filed: Mar. 21, 2025

Related U.S. Application Data
(63) Continuation of application No. PCT/CN2023/108148, filed on Jul. 19, 2023.

(30) Foreign Application Priority Data
Dec. 16, 2022 (CN) 202211621362.3

(51) Int. Cl. H01M 10/0567; H01M 10/0525; H01M 10/42

(52) U.S. Cl. CPC H01M 10/0567; H01M 10/0525; H01M 10/4235; H01M 2300/004

(57) ABSTRACT

Disclosed are an additive composition for a lithium-ion battery electrolyte, an electrolyte including the additive composition, and a use of the electrolyte. The additive composition includes an unsaturated cyclic carbonate and an unsaturated chain carbonate. The unsaturated cyclic carbonate comprises at least one of the following compounds: formula (1-a), formula (1-b) and formula (1-c); the unsaturated chain carbonate has a general structural formula represented by formula (2), wherein R₁ is a hydrocarbyl or fluorinated hydrocarbyl containing 1 to 6 carbon atoms, R₂ is a hydrocarbyl or fluorinated hydrocarbyl containing 1 to 6 carbon atoms; and group A is a vinylidene or an ethynylene. Lithium ion batteries using the electrolyte have the advantages of low impedance, excellent cycle performance and the like, and the batteries also have excellent high-temperature cycle performance and high-temperature storage performance.

### CROSS-REFERENCE TO RELATED APPLICATIONS

The present application is a continuation of PCT application serial no. PCT/CN2023/108148, filed on Jul. 19, 2023, which claims the priority benefits of China patent application No. 202211621362.3, filed on Dec. 16, 2022. The entireties of PCT application serial no. PCT/CN2023/108148 and China patent application No. 202211621362.3 are hereby incorporated by reference herein and made a part of this specification.

### FIELD OF THE INVENTION

The present application relates to the field of lithium-ion batteries and, in more particular, to an additive composition for a lithium-ion battery electrolyte, an electrolyte comprising the additive composition, and a use of the electrolyte.

### BACKGROUND OF THE INVENTION

Compared with conventional secondary batteries, lithium-ion batteries have greater energy density, higher voltage, and longer cycle life. In addition, lithium-ion batteries are environmentally friendly. In view of the foregoing, lithium-ion batteries have been widely used in many fields, such as laptops, mobile phones, digital products, and electric vehicles.

An important component of the lithium-ion battery is an electrolyte, which functions to transfer lithium ions between the cathode and anode of the battery. The electrolyte usually comprises a lithium salt electrolyte, an organic solvent and an additive composition. The introduction of the additive composition can improve the rate performance and cycle life of the battery, reduce the resistance of the battery, etc. Vinylene carbonate and vinyl ethylene carbonate are common film-forming additive compositions. Vinylene carbonate and vinyl carbonate will undergo electrochemical polymerization on the surface of the anode to form a dense solid electrolyte film to prevent an electrode material from contacting the electrolyte, thereby preventing the electrolyte from further reduction and decomposing on the surface of the anode, and inhibiting side reactions between the electrolyte and the electrode material. Moreover, the solid electrolyte film may also prevent the solvent and lithium ions from being co-embedded in the electrode material.

Power batteries are power supplies for tools. Sufficient film-forming additive compositions are required to ensure that the batteries have sufficient cycle stability. However, the increase in the amount of film-forming additive compositions will increase the cost, and the resistance of the batteries will also increase accordingly, and the rate performance and low-temperature performance of the batteries will be affected by the increase in the resistance of the batteries. In addition, when the amount of additive compositions such as vinylene carbonate, increases in lithium-ion batteries using lithium nickel cobalt manganese oxides as cathode materials, the batteries may swell obviously when working at high temperatures, posing a safety hazard.

In view of the foregoing, how to develop an additive composition that causes lithium-ion batteries to have low impedance, long cycle life, and excellent high-and low-temperature performance is an important topic in the field of lithium-ion batteries.

### SUMMARY

In order to obtain lithium-ion batteries with low impedance, long cycle life and excellent high-and low-temperature performance, the present application provides an additive composition for a lithium-ion battery electrolyte, an electrolyte comprising the additive composition and a use of the electrolyte.

In a first aspect, the present application provides an additive composition for a lithium-ion battery electrolyte and adopts the following technical solution.

An additive composition for a lithium-ion battery electrolyte, including an unsaturated cyclic carbonate and an unsaturated chain carbonate, wherein
the unsaturated cyclic carbonate includes at least one of the following compounds:

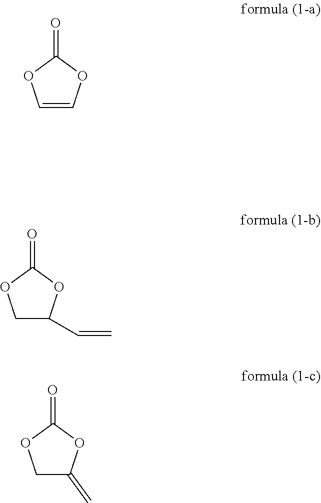

the unsaturated chain carbonate has the following general structural formula:

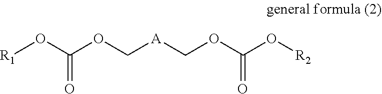

wherein R₁ is a hydrocarbyl or fluorinated hydrocarbyl containing 1 to 6 carbon atoms, and R₂ is a hydrocarbyl or fluorinated hydrocarbyl containing 1 to 6 carbon atoms; and group A is a vinylidene or an ethynylene.

In a specific embodiment, the unsaturated chain carbonate is at least one of the following compounds:

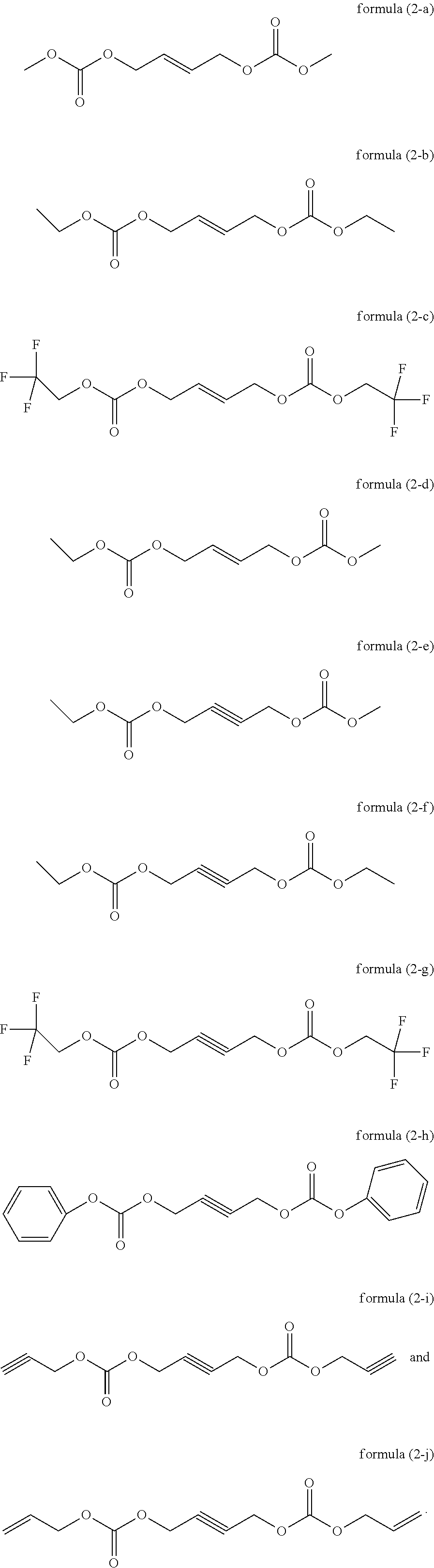

In a specific embodiment, a mass ratio of the unsaturated cyclic carbonate to the unsaturated chain carbonate is (0.5-5):(0.05-10).

In a second aspect, the present application provides a lithium-ion battery electrolyte and adopts the following technical solution.

A lithium-ion battery electrolyte, including a lithium salt electrolyte, an organic solvent and the additive composition.

In a specific embodiment, a mass percent of the unsaturated cyclic carbonate in the additive composition is 0.5%-5% in the lithium-ion battery electrolyte, and a mass percent of the unsaturated chain carbonate in the additive composition is 0.05%-10% in the lithium-ion battery electrolyte.

In a specific embodiment, the organic solvent is at least one selected from a group consisting of: dimethyl carbonate, diethyl carbonate, dipropyl carbonate, ethylene carbonate, ethyl methyl carbonate, methyl propyl carbonate, methyl butyl carbonate, propylene carbonate, γ-butyrolactone, methyl acetate, ethyl acetate, propyl acetate, butyl acetate, methyl propionate, ethyl propionate, propyl propionate, methyl butyrate, ethyl butyrate, difluoroethyl acetate, trifluoroethyl acetate, trifluoroethyl methyl carbonate, and bistrifluoroethyl carbonate.

In a specific embodiment, the lithium salt electrolyte is at least one selected from a group consisting of: lithium hexafluorophosphate, lithium tetrafluoroborate, lithium difluorophosphate, lithium perchlorate, lithium hexafluoroarsenate, lithium bis(fluorosulfonyl)imide, lithium bis(trifluoromethylsulfonyl)imide, lithium bis(oxalate)borate, lithium difluorooxalateborate, lithium tetrafluorooxalatephosphate, lithium difluorobis(oxalate)phosphate, and lithium fluorosulfonyl(trifluoromethylsulfonyl)imide. A molar concentration of the electrolyte in the lithium-ion battery electrolyte is 0.5-2 mol/L.

The lithium-ion battery electrolyte of the present application is suitable for lithium-ion batteries with lithium iron phosphorus oxide, lithium manganese oxide, lithium cobalt oxide, lithium nickel cobalt manganese oxide, lithium nickel cobalt aluminum oxide, lithium manganese iron phosphorus oxide, and lithium nickel cobalt manganese aluminum oxide as cathodes.

In a specific embodiment, the lithium-ion battery electrolyte of the present application is suitable for lithium-ion batteries with carbon materials or silicon-based materials as anodes.

In summary, the present application has the following beneficial effects.

The present application uses a mixture of the unsaturated cyclic carbonate and the unsaturated chain carbonate as the additive composition for use in the lithium-ion battery electrolyte. With suitable ratios, the lithium-ion batteries with low impedance, excellent cycle performance, especially low-temperature cycle performance, are obtained; the generation of gas caused by the decomposition of the lithium-ion battery electrolyte can be inhibited, and the high-temperature cycle and high-temperature storage performance of the batteries are improved.

### DETAILED DESCRIPTION

The present application is further described in detail with reference to examples below.

### EXAMPLES

An example of the present application provides a lithium-ion battery electrolyte.

A preparation method for the lithium-ion battery electrolyte includes the following steps:

Step 1, in a glove box filled with nitrogen or argon, where the water and oxygen contents are both at most 0.1 ppm, an organic solvent and a lithium salt electrolyte are evenly mixed to obtain a basic electrolyte;

Step 2, still in the glove box filled with nitrogen or argon, where the water and oxygen contents are both at most 0.1 ppm, an additive composition is added to the basic electrolyte and mixed evenly to obtain the lithium-ion battery electrolyte.

The additive composition in this example is a mixture of an unsaturated cyclic carbonate and an unsaturated chain carbonate.

The unsaturated cyclic carbonate in this example is selected from the following compounds:

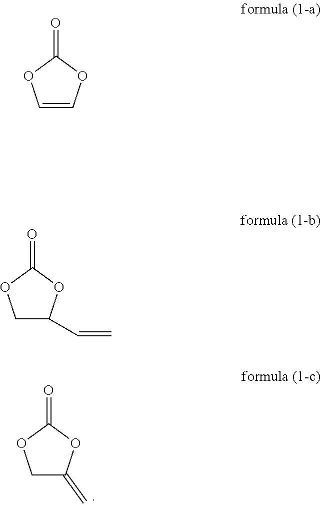

In this example, the unsaturated chain carbonate has the following general structural formula:

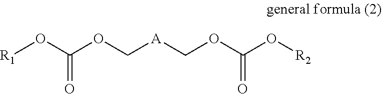

wherein R₁ is a hydrocarbyl or fluorinated hydrocarbyl containing 1 to 6 carbon atoms, and R₂ is a hydrocarbyl or fluorinated hydrocarbyl containing 1 to 6 carbon atoms; and group A is a vinylidene or an ethynylene.

Specifically, the unsaturated chain carbonate in this example is selected from the following compounds:

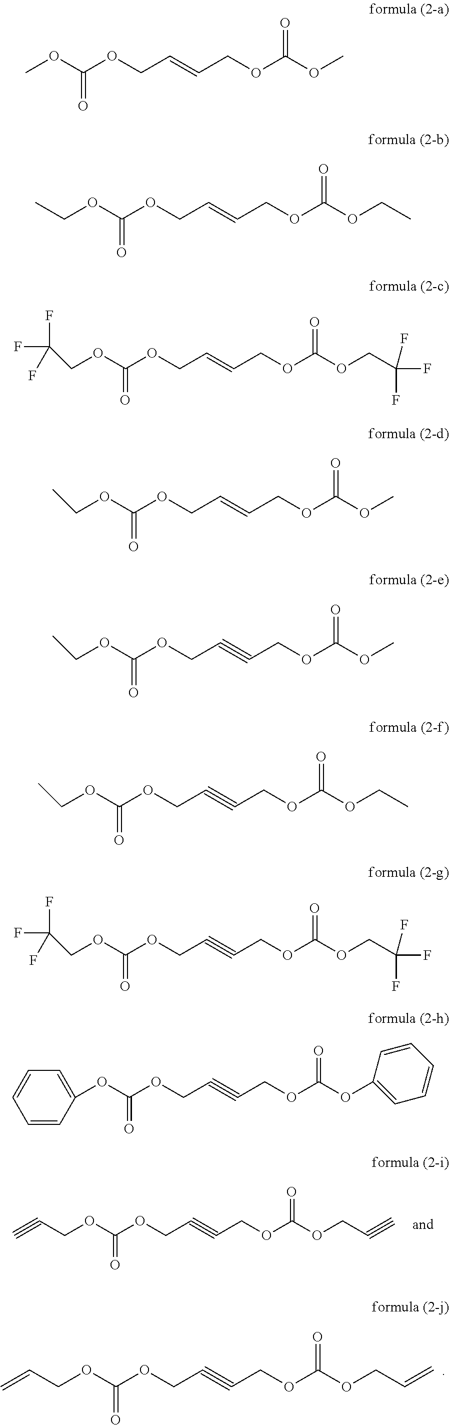

In a specific embodiment, the organic solvent is at least one selected from a group consisting of: dimethyl carbonate, diethyl carbonate, dipropyl carbonate, ethylene carbonate, ethyl methyl carbonate, methyl propyl carbonate, methyl butyl carbonate, propylene carbonate, γ-butyrolactone, methyl acetate, ethyl acetate, propyl acetate, butyl acetate, methyl propionate, ethyl propionate, propyl propionate, methyl butyrate, ethyl butyrate, difluoroethyl acetate, trifluoroethyl acetate, trifluoroethyl methyl carbonate, and bistrifluoroethyl carbonate.

Preferably, the organic solvent in this example is a mixture of ethylene carbonate, ethyl methyl carbonate and dimethyl carbonate; further, a volume ratio of ethylene carbonate to ethyl methyl carbonate to dimethyl carbonate is 1:1:1.

In this example, the lithium salt electrolyte is at least one selected from a group consisting of: lithium hexafluorophosphate, lithium tetrafluoroborate, lithium difluorophosphate, lithium perchlorate, lithium hexafluoroarsenate, lithium bis(fluorosulfonyl)imide, lithium bis(trifluoromethylsulfonyl)imide, lithium bis(oxalate)borate, lithium difluorooxalateborate, lithium tetrafluorooxalatephosphate, lithium difluorobis(oxalate)phosphate, and lithium fluorosulfonyl(trifluoromethylsulfonyl)imide. A molar concentration of the lithium salt electrolyte in the lithium-ion battery electrolyte is 0.5-2 mol/L.

Preferably, the lithium salt electrolyte in this example is lithium hexafluorophosphate, and the molar concentration of lithium hexafluorophosphate is 1 mol/L.

This example further provides a method for preparing a lithium-ion battery, including the following step:

In a glove box filled with nitrogen or argon, where the water and oxygen contents are both at most 0.1 ppm, the lithium-ion battery electrolytes in the examples and comparative examples are filled into lithium-ion battery cells with LiFePO₄ or LiNi_{0.5}Co_{0.2}Mn_{0.3}O₂ as a cathode material and an artificial graphite as an anode; after the filling of the lithium-ion battery electrolyte is completed, sealing, standing still, formation, aging, secondary sealing and capacity division are performed to obtain the lithium-ion battery.

This example further provides methods for detecting the performance of a lithium-ion battery, including the following detection methods:

(1) Method for testing the direct current internal resistance (DCIR) of lithium-ion batteries at room temperature.

For a lithium-ion battery with LiFePO₄ as the cathode material, the specific steps are as follows.

At 25° C., a formed battery is constant-current and constant-voltage charged to 3.65V at 1 C, with a cut-off current of 0.05 C, and then constant-current discharged to 2V at 1 C, and the discharge capacity Qt is recorded. Then, the battery is constant-current and constant-voltage charged to 3.65V at 1 C, with a cut-off current of 0.05 C, and then constant-current discharged by 50% Qt at 1 C. The battery is then allowed to stand still for 1 h and the voltage V₃ after standing is recorded; then, the battery is constant-current discharged at a current of 5 Qt for 10 s, and the voltage V₂ after discharge is recorded.

$$Discharge DCIR = ( {V}_{1} - {V}_{2} ) / ( 5 \times Qt ) .$$

For a lithium-ion battery with LiNi_{0.5}Co_{0.2}Mn_{0.3}O₂ as the cathode material, the specific steps are as follows.

At 25° C., a formed battery is constant-current and constant-voltage charged to 4.35V at 1 C, with a cut-off current of 0.05 C, and then constant-current discharged to 3V at 1 C, and the discharge capacity Qt is recorded. Then, the battery is constant-current and constant-voltage charged to 4.35V at 1 C, with a cut-off current of 0.05 C, and then constant-current discharged by 50% Qt at 1 C. The battery is then allowed to stand still for 1 h and the voltage V₃ after standing is recorded; then, the battery is constant-current discharged at a current of 5 Qt for 10 s, and the voltage V₄ after discharge is recorded.

$$Discharge DCIR = ( {V}_{3} - {V}_{4} ) / ( 5 \times Qt ) .$$

(2) Method for testing the cycle performance of lithium-ion batteries.

For the lithium-ion battery with LiFePO₄ as the cathode material, the specific steps are as follows.

a: At 25° C., a formed battery is constant-current and constant-voltage charged to 3.65V at 1 C, with a cut-off current of 0.05 C, and then constant-current discharged to 2V at 1 C. After 500 cycles of charge and discharge, the discharge capacity retention rate after 500 cycles is calculated.

$$Discharge capacity retention rate at 25 ° C . ( \% ) = discharge capacity after 500 cycles / discharge capacity after first cycle \times 100 \% .$$

b: At 0° C., a formed battery is constant-current and constant-voltage charged to 3.65V at 1 C, with a cut-off current of 0.05 C, and then constant-current discharged to 2V at 1 C. After 80 cycles of charge and discharge, the discharge capacity retention rate after 80 cycles is calculated.

$$Discharge capacity retention rate at 0 ° C . ( \% ) = discharge capacity after 80 cycles / discharge capacity after first cycle \times 100 \% .$$

For the lithium-ion battery with LiNi_{0.5}Co_{0.2}Mn_{0.3}O₂ as the cathode material, the specific steps are as follows.

a: At 25° C., a formed battery is constant-current and constant-voltage charged to 4.35V at 1 C, with a cut-off current of 0.05 C, and then constant-current discharged to 3V at 1 C. After 800 cycles of charge and discharge, the discharge capacity retention rate after 800 cycles is calculated.

$$Discharge capacity retention rate at 25 ° C . ( \% ) = discharge capacity after 800 cycles / discharge capacity after first cycle \times 100 \% .$$

b. At 45° C., a formed battery is constant-current and constant-voltage charged to 4.35V at 1 C, with a cut-off current of 0.05 C, and then constant-current discharged to 3V at 1 C. After 400 cycles of charge and discharge, the discharge capacity retention rate after 400 cycles is calculated.

$$Discharge capacity retention rate at 45 ° C . ( \% ) = discharge capacity after 400 cycles / discharge capacity after first cycle \times 100 \% .$$

(3) Method for testing the high-temperature storage performance of lithium-ion batteries.

For the lithium-ion battery with LiFePO₄ as the cathode material, the specific steps are as follows.

At 25° C., a battery is constant-current and constant-voltage charged to 3.65V at 0.5 C, with a cut-off current of 0.05 C, and then constant-current discharged to 2V at 0.5 C, and the discharge capacity (i.e., initial discharge capacity) is recorded. Then, the battery is constant-current and constant-voltage charged to 3.65V at 0.5 C. The fully charged battery is then placed in a 60° C. constant-temperature environment and stored for 7 days. 7 days later, let the battery stand still at 25° C. for 4 h, and after cooling to room temperature, the battery is constant-current discharged to 2V at 0.5 C, and the discharge capacity (i.e., retained capacity) is recorded. The battery is constant-current and constant-voltage charged to 3.65V at 0.5 C, with a cut-off current of 0.05 C, and then constant-current discharged to 2V at 0.5 C, and the discharge capacity (i.e., restored capacity) is recorded.

$$\begin{matrix}Battery capacity rentention rate ( \% ) = retained capacity / initial capacity \times 100 \% . \\ Battery capacity restoration rate ( \% ) = restored capacity / initial capacity \times 100 \% .\end{matrix}$$

In the lithium-ion battery with LiNi_{0.5}Co_{0.2}Mn_{0.3}O₂ as the cathode material, the specific steps are as follows.

At 25° C., a battery is constant-current and constant-voltage charged to 4.35V at 0.5 C, with a cut-off current of 0.05 C, and then constant-current discharged to 3V at 0.5 C, and the discharge capacity (i.e., initial discharge capacity) is recorded. Then, the battery is constant-current and constant-voltage charged to 4.35V at 0.5 C and the initial thickness of the battery is then measured. The fully charged battery is then placed in a 60° C. constant-temperature environment and stored for 7 days. 7 days later, let the battery stand still at 25° C. for 4 h, and after the battery cools to room temperature, the thickness of the stored battery is measured. The battery is then constant-current discharged to 3V at 0.5 C, and the discharge capacity (i.e., retained capacity) is recorded. The battery is constant-current and constant-voltage charged to 4.35V at 0.5 C, with a cut-off current of 0.05 C, and then constant-current discharged to 3V at 0.5 C, and the discharge capacity (i.e., restored capacity) is recorded.

$$\begin{matrix}Battery capacity rentention rate ( \% ) = retained capacity / initial capacity \times 100 \% . \\ Battery capacity restoration rate ( \% ) = restored capacity / initial capacity \times 100 \% . \\ Thickness swelling rate ( \% ) = ( thickness after storage - initial thickness ) / initial thickness \times 100 \% .\end{matrix}$$

The present application is described below by specific examples.

### Example 1

Provided was a preparation method for the lithium-ion battery electrolyte, including the following steps:

Step 1, in a glove box filled with nitrogen or argon, where the water and oxygen contents were both at most 0.1 ppm, ethylene carbonate, ethyl methyl carbonate and dimethyl carbonate were mixed evenly to obtain an organic solvent mixture; the volume ratio of ethylene carbonate to ethyl methyl carbonate to dimethyl carbonate was 1:1:1; then lithium hexafluorophosphate was added to the organic solvent mixture and mixed evenly to obtain a basic electrolyte, in which the concentration of lithium hexafluorophosphate was 1 mol/L;

Step 2, still in the glove box filled with nitrogen or argon, where the water and oxygen contents were both at most 0.1 ppm, the unsaturated cyclic carbonate in the additive composition and the unsaturated chain carbonate in the additive composition were added to the basic electrolyte and mixed evenly to obtain the lithium-ion battery electrolyte.

The unsaturated chain carbonate in Example 1 was the compound represented by formula (2-a), and the unsaturated cyclic carbonate was the compound represented by formula (1-a). And in the final lithium-ion battery electrolyte, the mass percent of the unsaturated chain carbonate was 1%, and the mass percent of the unsaturated cyclic carbonate was 1%.

Example 1 further provided a method for preparing a lithium-ion battery, including the following steps:

In a glove box filled with nitrogen or argon, where the water and oxygen contents were both at most 0.1 ppm, the lithium-ion battery electrolyte to be prepared was filled into a lithium-ion battery cell with LiFePO₄ as a cathode material and an artificial graphite as an anode. After the filling of the lithium-ion battery electrolyte was completed, sealing, standing still, formation, aging, secondary sealing and capacity division were performed to obtain the lithium-ion battery.

Example 1 further provided a method for testing the DCIR of the lithium-ion battery at room temperature, including the following steps:

At 25° C., a formed battery was constant-current and constant-voltage charged to 3.65V at 1 C, with a cut-off current of 0.05 C, and then constant-current discharged to 2V at 1 C, and the discharge capacity Qt was recorded. Then, the battery was constant-current and constant-voltage charged to 3.65V at 1 C, with a cut-off current of 0.05 C, and then constant-current discharged by 50% Qt at 1 C. The battery was then allowed to stand still for 1 h and the voltage V₁ after standing was recorded; then, the battery was constant-current discharged at a current of 5 Qt for 10 s, and the voltage V₂ after discharge was recorded.

$$Discharge DCIR = ( {V}_{1} - {V}_{2} ) / ( 5 \times Qt ) .$$

### Examples 2-6 and Comparative Examples 1-4

Examples 2-6 and Comparative Examples 1-4 differ from Example 1 in the formulation of the additive composition in the lithium-ion battery electrolyte. The lithium-ion batteries of Examples 2-6 and Comparative Examples 1-4 all used LiFePO₄ as the cathode material, and the methods for testing the performance of the lithium-ion batteries in Examples 2-6 and Comparative Examples 1-4 were the same as those in Example 1.

The additive composition formulations and battery performance test results of Examples 1-6 and Comparative Examples 1-4 are shown in Table 1.

TABLE 1
Additive composition formulations and battery performance
test results of Examples 1-6 and Comparative Examples 1-4

| | Formulation of additive composition | | | | |
|---|---|---|---|---|---|
| | Unsaturated cyclic | | Unsaturated chain | | |
| | carbonate | | carbonate | | Discharge |
| | General | | General | | DCIR |
| Battery | formula | Content | formula | Content | (mΩ) |
| Example 1 | 1-a | 1% | 2-a | 1% | 128.5 |
| Example 2 | 1-a | 1% | 2-b | 2% | 132.4 |
| Example 3 | 1-a | 2% | 2-e | 3% | 140.1 |
| Example 4 | 1-a | 1% | 2-f | 3% | 137.2 |
| Example 5 | 1-b | 1% | 2-a | 3% | 150.5 |
| Example 6 | 1-c | 2% | 2-e | 3% | 160.1 |
| Comparative | 1-a | 1% | / | 0 | 149.1 |
| Example 1 | | | | | |
| Comparative | 1-a | 2% | / | 0 | 156.4 |
| Example 2 | | | | | |
| Comparative | 1-b | 1% | / | 0 | 169.3 |
| Example 3 | | | | | |
| Comparative | 1-c | 2% | / | 0 | 178.5 |
| Example 4 | | | | | |

### Example 7

Provided was a preparation method for the lithium-ion battery electrolyte, including the following steps:

Step 1, in a glove box filled with nitrogen or argon, where the water and oxygen contents were both at most 0.1 ppm, ethylene carbonate, ethyl methyl carbonate and dimethyl carbonate were mixed evenly to obtain an organic solvent mixture; the volume ratio of ethylene carbonate to ethyl methyl carbonate to dimethyl carbonate was 1:1:1; then lithium hexafluorophosphate was added to the organic solvent mixture and mixed evenly to obtain a basic electrolyte, in which the concentration of lithium hexafluorophosphate was 1 mol/L;

Step 2, still in the glove box filled with nitrogen or argon, where the water and oxygen contents were both at most 0.1 ppm, the unsaturated cyclic carbonate in the additive composition and the unsaturated chain carbonate in the additive composition were added to the basic electrolyte and mixed evenly to obtain the lithium-ion battery electrolyte.

The unsaturated chain carbonate in Example 7 was the compound represented by formula (2-b), and the unsaturated cyclic carbonate was the compound represented by formula (1-a). And in the final lithium-ion battery electrolyte, the mass percent of the unsaturated chain carbonate was 1%, and the mass percent of the unsaturated cyclic carbonate was 1%.

Example 7 further provided a method for preparing a lithium-ion battery, including the following steps:

In a glove box filled with nitrogen or argon, where the water and oxygen contents were both at most 0.1 ppm, the lithium-ion battery electrolyte to be prepared was filled into a lithium-ion battery cell with LiNi_{0.5}Co_{0.2}Mn_{0.3}O₂ as a cathode material and an artificial graphite as an anode. After the filling of the lithium-ion battery electrolyte was completed, sealing, standing still, formation, aging, secondary sealing and capacity division were performed to obtain the lithium-ion battery.

Example 7 further provided a method for testing the DCIR of the lithium-ion battery at room temperature, including the following steps:

At 25° C., a formed battery was constant-current and constant-voltage charged to 4.35V at 1 C, with a cut-off current of 0.05 C, and then constant-current discharged to 3V at 1 C, and the discharge capacity Qt was recorded. Then, the battery was constant-current and constant-voltage charged to 4.35V at 1 C, with a cut-off current of 0.05 C, and then constant-current discharged by 50% Qt at 1 C. The battery was then allowed to stand still for 1 h and the voltage V₃ after standing was recorded; then, the battery was constant-current discharged at a current of 5 Qt for 10 s, and the voltage V₄ after discharge was recorded.

$$Discharge DCIR = ( {V}_{3} - {V}_{4} ) / ( 5 \times Qt ) .$$

### Examples 8-12 and Comparative Examples 5-8

Examples 8-12 and Comparative Examples 5-8 differ from Example 7 in the formulation of the additive composition in the lithium-ion battery electrolyte. The lithium-ion batteries of Examples 8-12 and Comparative Examples 5-8 all used LiNi_{0.5}Co_{0.2}Mn_{0.3}O₂ as the cathode material, and the methods for testing the performance of the lithium-ion batteries in Examples 8-12 and Comparative Examples 5-8 were the same as those in Example 7.

The additive composition formulations and battery performance test results of Examples 7-12 and Comparative Examples 5-8 are shown in Table 2.

TABLE 2
Additive composition formulations and battery performance
test results of Examples 7-12 and Comparative Examples 5-8

| | Formulation of additive composition | | | | |
|---|---|---|---|---|---|
| | Unsaturated cyclic | | Unsaturated chain | | |
| | carbonate | | carbonate | | Discharge |
| | General | | General | | DCIR |
| Battery | formula | Content | formula | Content | (mΩ) |
| Example 7 | 1-a | 1% | 2-b | 1% | 98.6 |
| Example 8 | 1-a | 1% | 2-c | 1% | 89.1 |
| Example 9 | 1-b | 1% | 2-e | 3% | 109.8 |
| Example 10 | 1-b | 2% | 2-f | 1% | 128.5 |
| Example 11 | 1-b | 2% | 2-i | 1% | 139.6 |
| Example 12 | 1-c | 1% | 2-f | 0.50% | 107.6 |
| Comparative | 1-a | 1% | / | 0 | 112.5 |
| Example 5 | | | | | |
| Comparative | 1-b | 1% | / | 0 | 134.5 |
| Example 6 | | | | | |
| Comparative | 1-b | 2% | / | 0 | 153.3 |
| Example 7 | | | | | |
| Comparative | 1-c | 1% | | 0 | 125.6 |
| Example 8 | | | | | |

From the test results of Examples 1-12 and Comparative Examples 1-8 in Table 1 and Table 2, it can be seen that the lithium-ion battery electrolytes using the additive compositions of the present application, for both batteries based on a lithium iron phosphorous oxide system and batteries based on a nickel-cobalt-manganese ternary system, have a significantly reduced discharge DCIC, as compared to the comparative examples using the first component additive alone.

### Example 13

Provided was a preparation method for the lithium-ion battery electrolyte, including the following steps:

Step 1, in a glove box filled with nitrogen or argon, where the water and oxygen contents were both at most 0.1 ppm, ethylene carbonate, ethyl methyl carbonate and dimethyl carbonate were mixed evenly to obtain an organic solvent mixture; the volume ratio of ethylene carbonate to ethyl methyl carbonate to dimethyl carbonate was 1:1:1, then lithium hexafluorophosphate was added to the organic solvent mixture and mixed evenly to obtain a basic electrolyte, in which the concentration of lithium hexafluorophosphate was 1 mol/L;

Step 2, still in the glove box filled with nitrogen or argon, where the water and oxygen contents were both at most 0.1 ppm, the unsaturated cyclic carbonate in the additive composition and the unsaturated chain carbonate in the additive composition were added to the basic electrolyte and mixed evenly to obtain the lithium-ion battery electrolyte.

The unsaturated chain carbonate in Example 13 was the compound represented by formula (2-b), and the unsaturated cyclic carbonate was the compound represented by formula (1-a). And in the final lithium-ion battery electrolyte, the mass percent of the unsaturated chain carbonate was 2%, and the mass percent of the unsaturated cyclic carbonate was 1%.

Example 13 further provided a method for preparing a lithium-ion battery, including the following steps:

In a glove box filled with nitrogen or argon, where the water and oxygen contents were both at most 0.1 ppm, the lithium-ion battery electrolyte to be prepared was filled into a lithium-ion battery cell with LiFePO₄ as a cathode material and an artificial graphite as an anode. After the filling of the lithium-ion battery electrolyte was completed, sealing, standing still, formation, aging, secondary sealing and capacity division were performed to obtain the lithium-ion battery.

Example 13 further provided a method for testing the cycle performance of the lithium-ion battery, including the following steps:

(1) At 25° C., a formed battery is constant-current and constant-voltage charged to 3.65V at 1 C, with a cut-off current of 0.05 C, and then constant-current discharged to 2V at 1 C. After 500 cycles of charge and discharge, the discharge capacity retention rate after 500 cycles was calculated.

$$Discharge capacity retention rate at 25 ° C . ( \% ) = discharge capacity after 500 cycles / discharge capacity after first cycle \times 100 \% .$$

(2) At 0° C., a formed battery was constant-current and constant-voltage charged to 3.65V at 1 C, with a cut-off current of 0.05 C, and then constant-current discharged to 2V at 1 C. After 80 cycles of charge and discharge, the discharge capacity retention rate after 80 cycles was calculated.

$$Discharge capacity retention rate at 0 ° C . ( \% ) = discharge capacity after 80 cycles / discharge capacity after first cycle \times 100 \% .$$

### Examples 14-18 and Comparative Examples 9-12

Examples 14-18 and Comparative Examples 9-12 differ from Example 13 in the formulation of the additive composition in the lithium-ion battery electrolyte. The lithium-ion batteries of Examples 14-18 and Comparative Examples 9-12 all used LiFePO₄ as the cathode material, and the methods for testing the performance of the lithium-ion batteries in Examples 14-18 and Comparative Examples 9-12 were the same as those in Example 13.

The additive composition formulations and battery performance test results of Examples 13-18 and Comparative Examples 9-12 are shown in Table 3.

TABLE 3
Additive composition formulations and battery performance test
results of Examples 13-18 and Comparative Examples 9-12

| | Formulation of additive composition | | | | Cycle capacity | |
|---|---|---|---|---|---|---|
| | Unsaturated | | Unsaturated | | retention rate % | |
| | cyclic carbonate | | chain carbonate | | 25° C. | 0° C. |
| | General | | General | | (lC/lC | (lC/lC |
| Battery | formula | Content | formula | Content | 500 cycles) | 80 cycles) |
| Example 13 | 1-a | 1% | 2-b | 2% | 86.5 | 81.1 |
| Example 14 | 1-a | 1% | 2-e | 2% | 88.6 | 86.2 |
| Example 15 | 1-a | 1% | 2-f | 3% | 89.2 | 92.2 |
| Example 16 | 1-a | 2% | 2-i | 3% | 91.2 | 68.4 |
| Example 17 | 1-b | 1% | 2-a | 1% | 80.2 | 75.8 |
| Example 18 | 1-c | 1% | 2-f | 3% | 83.6 | 88.2 |
| Comparative | 1-a | 1% | / | 0 | 81.6 | 55.6 |
| Example 9 | | | | | | |
| Comparative | 1-a | 2% | / | 0 | 86.5 | 28.5 |
| Example 10 | | | | | | |
| Comparative | 1-b | 1% | / | 0 | 72.9 | 40.9 |
| Example 11 | | | | | | |
| Comparative | 1-c | 1% | / | 0 | 76.1 | 50.1 |
| Example 12 | | | | | | |

### Example 19

Provided was a preparation method for the lithium-ion battery electrolyte, including the following steps:

Step 1, in a glove box filled with nitrogen or argon, where the water and oxygen contents were both at most 0.1 ppm, ethylene carbonate, ethyl methyl carbonate and dimethyl carbonate were mixed evenly to obtain an organic solvent mixture; the volume ratio of ethylene carbonate to ethyl methyl carbonate to dimethyl carbonate was 1:1:1; then lithium hexafluorophosphate was added to the organic solvent mixture and mixed evenly to obtain a basic electrolyte, in which the concentration of lithium hexafluorophosphate was 1 mol/L;

Step 2, still in the glove box filled with nitrogen or argon, where the water and oxygen contents were both at most 0.1 ppm, the unsaturated cyclic carbonate in the additive composition and the unsaturated chain carbonate in the additive composition were added to the basic electrolyte and mixed evenly to obtain the lithium-ion battery electrolyte.

The unsaturated chain carbonate in Example 19 was the compound represented by formula (2-a), and the unsaturated cyclic carbonate was the compound represented by formula (1-a). And in the final lithium-ion battery electrolyte, the mass percent of the unsaturated chain carbonate was 0.5%, and the mass percent of the unsaturated cyclic carbonate was 1%.

Example 19 further provided a method for preparing a lithium-ion battery, including the following steps:

In a glove box filled with nitrogen or argon, where the water and oxygen contents were both at most 0.1 ppm, the lithium-ion battery electrolyte to be prepared was filled into a lithium-ion battery cell with LiNi_{0.5}Co_{0.2}Mn_{0.3}O₂ as a cathode material and an artificial graphite as an anode. After the filling of the lithium-ion battery electrolyte was completed, sealing, standing still, formation, aging, secondary sealing and capacity division were performed to obtain the lithium-ion battery.

Example 19 further provided a method for testing the cycle performance of lithium-ion batteries, including the following steps:

(1) At 25° C., a formed battery was constant-current and constant-voltage charged to 4.35V at 1 C, with a cut-off current of 0.05 C, and then constant-current discharged to 3V at 1 C. After 800 cycles of charge and discharge, the discharge capacity retention rate after 800 cycles was calculated.

$$Discharge capacity retention rate at 25 ° C . ( \% ) = discharge capacity after 800 cycles / discharge capacity after first cycle \times 100 \% .$$

(2) At 45° C., a formed battery was constant-current and constant-voltage charged to 4.35V at 1 C, with a cut-off current of 0.05 C, and then constant-current discharged to 3V at 1 C. After 400 cycles of charge and discharge, the discharge capacity retention rate after 400 cycles was calculated.

$$Discharge capacity retention rate at 45 ° C . ( \% ) = discharge capacity after 400 cycles / discharge capacity after first cycle \times 100 \% .$$

### Examples 20-24 and Comparative Examples 13-16

Examples 20-24 and Comparative Examples 13-16 differ from Example 19 in the formulation of the additive composition in the lithium-ion battery electrolyte. The lithium-ion batteries of Examples 20-24 and Comparative Examples 13-16 all used LiNi_{0.5}Co_{0.2}Mn_{0.3}O₂ as the cathode material, and the methods for testing the performance of the lithium-ion batteries in Examples 20-24 and Comparative Examples 13-16 were the same as those in Example 19.

The additive composition formulations and battery performance test results of Examples 19-24 and Comparative Examples 13-16 are shown in Table 4.

TABLE 4
Additive composition formulations and battery performance test
results of Examples 19-24 and Comparative Examples 13-16

| | Formulation of | | | | | |
|---|---|---|---|---|---|---|
| | additive composition | | | | Cycle capacity | |
| | Unsaturated | | Unsaturated | | retention rate % | |
| | cyclic carbonate | | chain carbonate | | 25° C. | 45° C. |
| | General | | General | | (lC/lC | (1 C/1 C |
| Battery | formula | Content | formula | Content | 800 cycles) | 400 cycles) |
| Example 19 | 1-a | 1% | 2-a | 0.5% | 90.2 | 89.6 |
| Example 20 | 1-a | 1% | 2-c | 1% | 91.5 | 90.6 |
| Example 21 | 1-b | 1% | 2-a | 1% | 88.1 | 86.5 |
| Example 22 | 1-b | 1% | 2-e | 3% | 89.4 | 88.6 |
| Example 23 | 1-b | 2% | 2-f | 1% | 85.1 | 83.6 |
| Example 24 | 1-c | 1% | 2-e | 0.5% | 87.6 | 84.3 |
| Comparative | 1-a | 1% | / | 0 | 85.2 | 83.6 |
| Example 13 | | | | | | |
| Comparative | 1-b | 1% | / | 0 | 82.3 | 78.6 |
| Example 14 | | | | | | |
| Comparative | 1-b | 2% | / | 0 | 79.2 | 75.3 |
| Example 15 | | | | | | |
| Comparative | 1-c | 1% | / | 0 | 83.5 | 79.6 |
| Example 16 | | | | | | |

From the test results of Examples 13-24 and Comparative Examples 9-16 in Table 3 and Table 4, it can be seen that the batteries including the lithium-ion battery electrolytes using the additive compositions of the present application have a higher room-temperature capacity retention rate, as compared to the comparative examples, regardless of the batteries based on a lithium iron phosphorous oxide system and batteries based on a nickel-cobalt-manganese ternary system. In batteries based on the lithium iron phosphorous oxide system, the electrolytes using the additive compositions of the present application have a significantly improved low-temperature capacity retention rate, as compared with comparative examples. In batteries based on the nickel-cobalt-manganese ternary system, the electrolytes using the additive compositions of the present application also have a significantly improved high-temperature capacity retention rate.

### Example 25

Provided was a preparation method for the lithium-ion battery electrolyte, including the following steps:

Step 1, in a glove box filled with nitrogen or argon, where the water and oxygen contents were both at most 0.1 ppm, ethylene carbonate, ethyl methyl carbonate and dimethyl carbonate were mixed evenly to obtain an organic solvent mixture; the volume ratio of ethylene carbonate to ethyl methyl carbonate to dimethyl carbonate was 1:1:1, then lithium hexafluorophosphate was added to the organic solvent mixture and mixed evenly to obtain a basic electrolyte, in which the concentration of lithium hexafluorophosphate was 1 mol/L;

Step 2, still in the glove box filled with nitrogen or argon, where the water and oxygen contents were both at most 0.1 ppm, the unsaturated cyclic carbonate in the additive composition and the unsaturated chain carbonate in the additive composition were added to the basic electrolyte and mixed evenly to obtain the lithium-ion battery electrolyte.

The unsaturated chain carbonate in Example 25 was the compound represented by formula (2-a), and the unsaturated cyclic carbonate was the compound represented by formula (1-a). And in the final lithium-ion battery electrolyte, the mass percent of the unsaturated chain carbonate was 1%, and the mass percent of the unsaturated cyclic carbonate was 1%.

Example 25 further provided a method for preparing a lithium-ion battery, including the following steps:

In a glove box filled with nitrogen or argon, where the water and oxygen contents were both at most 0.1 ppm, the lithium-ion battery electrolyte to be prepared was filled into a lithium-ion battery cell with LiFePO₄ as a cathode material and an artificial graphite as an anode. After the filling of the lithium-ion battery electrolyte was completed, sealing, standing still, formation, aging, secondary sealing and capacity division were performed to obtain the lithium-ion battery.

Example 25 further provided a method for testing the high-temperature storage performance of the lithium-ion battery, including the following steps:

At 25° C., a battery is constant-current and constant-voltage charged to 3.65V at 0.5 C, with a cut-off current of 0.05 C, and then constant-current discharged to 2V at 0.5 C, and the discharge capacity (i.e., initial discharge capacity) is recorded. Then, the battery was constant-current and constant-voltage charged to 3.65V at 0.5 C. The fully charged battery was then placed in a 60° C. constant-temperature environment and stored for 7 days. 7 days later, the battery was allowed to stand still at 25° C. for 4 h, and after cooling to room temperature, the battery was constant-current discharged to 2V at 0.5 C, and the discharge capacity (i.e., retained capacity) was recorded. The battery was constant-current and constant-voltage charged to 3.65V at 0.5 C, with a cut-off current of 0.05 C, and then constant-current discharged to 2V at 0.5 C, and the discharge capacity (i.e., restored capacity) was recorded.

$$\begin{matrix}Battery capacity rentention rate ( \% ) = retained capacity / initial capacity \times 100 \% . \\ Battery capacity restoration rate ( \% ) = restored capacity / initial capacity \times 100 \% .\end{matrix}$$

### Examples 26-30 and Comparative Examples 17-20

Examples 26-30 and Comparative Examples 17-20 differ from Example 25 in the formulation of the additive composition in the lithium-ion battery electrolyte. The lithium-ion batteries of Examples 26-30 and Comparative Examples 17-20 all used LiFePO₄ as the cathode material, and the methods for testing the performance of the lithium-ion batteries in Examples 26-30 and Comparative Examples 17-20 were the same as those in Example 25.

The additive composition formulations and battery performance test results of Examples 25-30 and Comparative Examples 17-20 are shown in Table 5.

TABLE 5
Additive composition formulations and battery performance test
results of Examples 25-30 and Comparative Examples 17-20

| | Formulation of | | | | | |
|---|---|---|---|---|---|---|
| | additive composition | | | | High-temperature storage | |
| | Unsaturated | | Unsaturated | | performance (60° C. 7 days) | |
| | cyclic carbonate | | chain carbonate | | Capacity | Capacity |
| | General | | General | | retention | restoration |
| Battery | formula | Content | formula | Content | rate, % | rate, % |
| Example 25 | 1-a | 1% | 2-a | 1% | 91.6 | 93.9 |
| Example 26 | 1-a | 1% | 2-b | 2% | 92.0 | 94.2 |
| Example 27 | 1-a | 2% | 2-f | 3% | 93.9 | 95.4 |
| Example 28 | 1-a | 2% | 2-i | 3% | 94.3 | 95.9 |
| Example 29 | 1-b | 1% | 2-e | 2% | 95.8 | 97.3 |
| Example 30 | 1-c | 2% | 2-i | 3% | 92.0 | 93.9 |
| Comparative | 1-a | 1% | / | 0 | 88.2 | 90.2 |
| Example 17 | | | | | | |
| Comparative | 1-a | 2% | / | 0 | 89.3 | 91.8 |
| Example 18 | | | | | | |
| Comparative | 1-b | 1% | / | 0 | 90.1 | 92.9 |
| Example 19 | | | | | | |
| Comparative | 1-C | 2% | / | 0 | 88.2 | 90.4 |
| Example 20 | | | | | | |

### Example 31

Provided was a preparation method for the lithium-ion battery electrolyte, including the following steps:

Step 1, in a glove box filled with nitrogen or argon, where the water and oxygen contents were both at most 0.1 ppm, ethylene carbonate, ethyl methyl carbonate and dimethyl carbonate were mixed evenly to obtain an organic solvent mixture; the volume ratio of ethylene carbonate to ethyl methyl carbonate to dimethyl carbonate was 1:1:1; then lithium hexafluorophosphate was added to the organic solvent mixture and mixed evenly to obtain a basic electrolyte, in which the concentration of lithium hexafluorophosphate was 1 mol/L;

Step 2, still in the glove box filled with nitrogen or argon, where the water and oxygen contents were both at most 0.1 ppm, the unsaturated cyclic carbonate in the additive composition and the unsaturated chain carbonate in the additive composition were added to the basic electrolyte and mixed evenly to obtain the lithium-ion battery electrolyte.

The unsaturated chain carbonate in Example 31 was the compound represented by formula (2-b), and the unsaturated cyclic carbonate was the compound represented by formula (1-a). And in the final lithium-ion battery electrolyte, the mass percent of the unsaturated chain carbonate was 1%, and the mass percent of the unsaturated cyclic carbonate was 1%.

Example 31 further provided a method for preparing a lithium-ion battery, including the following steps:

In a glove box filled with nitrogen or argon, where the water and oxygen contents were both at most 0.1 ppm, the lithium-ion battery electrolyte to be prepared was filled into a lithium-ion battery cell with LiNi_{0.5}Co_{0.2}Mn_{0.3}O₂ as a cathode material and artificial graphite as an anode. After the filling of the lithium-ion battery electrolyte was completed, sealing, standing still, formation, aging, secondary sealing and capacity division were performed to obtain the lithium-ion battery.

Example 31 further provided a method for testing the high-temperature storage performance of the lithium-ion battery, including the following steps:

At 25° C., a battery was constant-current and constant-voltage charged to 4.35V at 0.5 C, with a cut-off current of 0.05 C, and then constant-current discharged to 3V at 0.5 C, and the discharge capacity (i.e., initial discharge capacity) was recorded. Then, the battery was constant-current and constant-voltage charged to 4.35V at 0.5 C and the initial thickness of the battery was then measured. The fully charged battery was then placed in a 60° C. constant-temperature environment and stored for 7 days. 7 days later, the battery was allowed to stand still at 25° C. for 4 h, and after the battery cooled to room temperature, the thickness of the stored battery was measured. The battery was then constant-current discharged to 3V at 0.5 C, and the discharge capacity (i.e., retained capacity) was recorded. The battery was constant-current and constant-voltage charged to 4.35V at 0.5 C, with a cut-off current of 0.05 C, and then constant-current discharged to 3V at 0.5 C, and the discharge capacity (i.e., restored capacity) was recorded.

$$\begin{matrix}Battery capacity rentention rate ( \% ) = retained capacity / initial capacity \times 100 \% . \\ Battery capacity restoration rate ( \% ) = restored capacity / initial capacity \times 100 \% . \\ Thickness swelling rate ( \% ) = ( thickness after storage - initial thickness ) / initial thickness \times 100 \% .\end{matrix}$$

### Examples 32-36 and Comparative Examples 21-24

Examples 32-36 and Comparative Examples 21-24 differ from Example 31 in the formulation of the additive composition in the lithium-ion battery electrolyte. The lithium-ion batteries of Examples 32-36 and Comparative Examples 21-24 all used LiNi_{0.5}Co_{0.2}Mn_{0.3}O₂ as a cathode material, and the methods for testing the performance of the lithium-ion batteries in Examples 32-36 and Comparative Examples 21-24 were the same as those in Example 31.

The additive composition formulations and battery performance test results of Examples 31-36 and Comparative Examples 21-24 are shown in Table 6.

TABLE 6
Additive composition formulations and battery performance test
results of Examples 31-36 and Comparative Examples 21-24

| | Formulation of additive composition | | | | High-temperature storage | | |
|---|---|---|---|---|---|---|---|
| | Unsaturated | | Unsaturated | | performance (60° C. 7 days) | | |
| | cyclic carbonate | | chain carbonate | | Capacity | Capacity | Thickness |
| | General | | General | | retention | restoration | swelling |
| Battery | formula | Content | formula | Content | rate, % | rate, % | rate, % |
| Example 31 | 1-a | 1% | 2-b | 1% | 84.6 | 89.6 | 5.5 |
| Example 32 | 1-a | 1% | 2-c | 1% | 84.9 | 90.9 | 4.9 |
| Example 33 | 1-b | 1% | 2-a | 3% | 89.2 | 94.8 | 2.9 |
| Example 34 | 1-b | 2% | 2-c | 1% | 90.6 | 97.5 | 2.6 |
| Example 35 | 1-b | 2% | 2-f | 1% | 90.1 | 96.3 | 3.1 |
| Example 36 | 1-c | 2% | 2-e | 3% | 88.6 | 94.5 | 3.9 |
| Comparative | 1-a | 1% | / | 0 | 75.0 | 82.1 | 10.5 |
| Example 21 | | | | | | | |
| Comparative | 1-b | 1% | / | 0 | 79.2 | 86.2 | 7.6 |
| Example 22 | | | | | | | |
| Comparative | 1-b | 2% | / | 0 | 83.7 | 92.1 | 5.2 |
| Example 23 | | | | | | | |
| Comparative | 1-c | 2% | / | 0 | 82.1 | 90.8 | 6.3 |
| Example 24 | | | | | | | |

From the test results of Examples 25-36 and Comparative Examples 17-24 in Table 5 and Table 6, it can be seen that the capacity retention rate and capacity restoration rate after high-temperature storage in the comparative examples were at normal levels, while for the batteries including the lithium-ion battery electrolytes using the additive compositions of the present application, the high-temperature storage performance can be improved and the battery swelling after high-temperature storage is also inhibited, regardless of whether the cathode materials of the batteries are lithium iron phosphorus oxide or the nickel-cobalt-manganese ternary system.

In summary, the present application uses a mixture of the unsaturated cyclic carbonate and the unsaturated chain carbonate as the additive composition for use in the lithium-ion battery electrolyte. With suitable ratios, the lithium-ion batteries with low impedance, excellent cycle performance, especially low-temperature cycle performance, are obtained; the gas generation caused by the decomposition of the electrolyte can be inhibited, and the high-temperature cycle and high-temperature storage performance of the batteries are improved.

The specific examples are merely an explanation of the present application and not for limiting the present application. Those skilled in the art may make modifications, without creative contribution, to the examples as needed after reading this specification. Any of the modifications made within the scope of the claims of the present application shall be protected by the Patent Law.

What is claimed is:

1. An additive composition for a lithium-ion battery electrolyte, comprising an unsaturated cyclic carbonate and an unsaturated chain carbonate; wherein
the unsaturated cyclic carbonate comprises at least one of the following compounds: 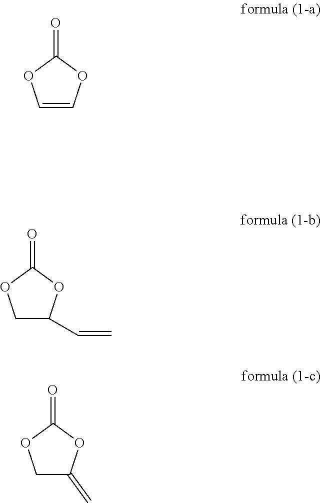
the unsaturated chain carbonate has the following general structural formula: 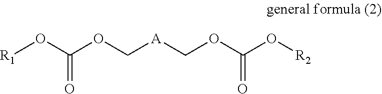
wherein R₁ is a hydrocarbyl or fluorinated hydrocarbyl containing 1 to 6 carbon atoms, R₂ is a hydrocarbyl or fluorinated hydrocarbyl containing 1 to 6 carbon atoms, and group A is a vinylidene or an ethynylene.

2. The additive composition for the lithium-ion battery electrolyte according to claim 1, wherein the unsaturated chain carbonate is at least one of the following compounds:

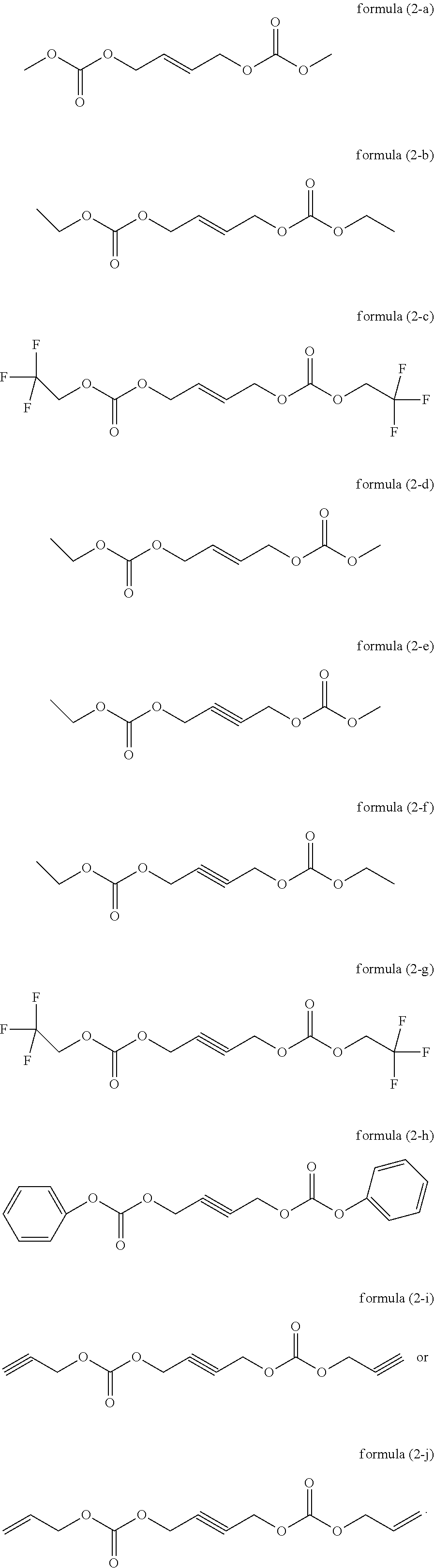

3. The additive composition for the lithium-ion battery electrolyte according to claim 1, wherein a mass ratio of the unsaturated cyclic carbonate to the unsaturated chain carbonate is (0.5-5):(0.05-10).

4. A lithium-ion battery electrolyte, comprising a lithium salt electrolyte, an organic solvent and the additive composition according to claim 1.

5. The lithium-ion battery electrolyte according to claim 4, wherein a mass percent of the unsaturated cyclic carbonate in the additive composition is 0.5%- 5% in the lithium-ion battery electrolyte, and a mass percent of the unsaturated chain carbonate in the additive composition is 0.05%- 10% in the lithium-ion battery electrolyte.

6. The lithium-ion battery electrolyte according to claim 4, wherein the organic solvent is at least one selected from a group consisting of: dimethyl carbonate, diethyl carbonate, dipropyl carbonate, ethylene carbonate, ethyl methyl carbonate, methyl propyl carbonate, methyl butyl carbonate, propylene carbonate, γ-butyrolactone, methyl acetate, ethyl acetate, propyl acetate, butyl acetate, methyl propionate, ethyl propionate, propyl propionate, methyl butyrate, ethyl butyrate, difluoroethyl acetate, trifluoroethyl acetate, trifluoroethyl methyl carbonate, and bistrifluoroethyl carbonate.

7. The lithium-ion battery electrolyte according to claim 4, wherein the lithium salt electrolyte is at least one selected from a group consisting of: lithium hexafluorophosphate, lithium tetrafluoroborate, lithium difluorophosphate, lithium perchlorate, lithium hexafluoroarsenate, lithium bis(fluorosulfonyl)imide, lithium bis(trifluoromethylsulfonyl)imide, lithium bis(oxalate)borate, lithium difluorooxalateborate, lithium tetrafluorooxalatephosphate, lithium difluorobis(oxalate)phosphate, and lithium fluorosulfonyl (trifluoromethylsulfonyl)imide, and a molar concentration of the lithium salt electrolyte in the lithium-ion battery electrolyte is 0.5-2 mol/L.

8. Use of the lithium-ion battery electrolyte according to claim 4, wherein the lithium-ion battery electrolyte is used in lithium-ion batteries with lithium iron phosphorus oxide, lithium manganese oxide, lithium cobalt oxide, lithium nickel cobalt manganese oxide, lithium nickel cobalt aluminum oxide, lithium nickel cobalt manganese aluminum oxide and lithium manganese iron phosphorus oxide as cathodes.

9. The use according to claim 8, wherein the lithium-ion battery electrolyte is used in lithium-ion batteries with carbon materials or silicon-based materials as anodes.
